(19) United States
(12) Patent Application Publication
(10) Pub. No.: US 2007/0153053 A1
(43) Pub. Date: Jul. 5, 2007

(54) Nozzle for inkjet printer head and method of manufacturing thereof

(75) Inventor: Kae Dong Back, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/476,879

(22) Filed: Jun. 29, 2006

(30) Foreign Application Priority Data
Dec. 29, 2005 (KR) 2005-133053

(51) Int. Cl. B41J 2/135

(52) U.S. Cl. 347/45

(57) ABSTRACT

A nozzle of an inkjet printer which can improve straightness of an ink, and a method of manufacturing the same. Initially, a seed metal layer can be formed on a nozzle having an ink path and a liquid photocurable resin is filled therein. The photocurable resin is hardened by emitting a light including ultraviolet rays to a nozzle plate. Next, the seed metal layer is partially exposed in the path of the nozzle by partially etching the hardened photocurable resin, and a waterproof layer is formed on the seed metal layer. Also, the photocurable resin is put into a solvent and removed. Since the waterproof layer is evenly formed in the path of the nozzle to a predetermined depth, an ink can evenly fill therein. Accordingly, it is possible to improve straightness of the ink, thereby enabling accurate printing.

### CROSS-REFERENCE TO RELATED APPLICATIONS

This application claims priority from Korean Patent Application No. 10-2005-0133053, filed on Dec. 29, 2005, in the Korean Intellectual Property Office, the disclosure of which is incorporated herein in its entirety by reference.

### BACKGROUND OF THE INVENTION

1. Field of the Invention

The present general inventive concept relates to a nozzle of a printer head and a method of manufacturing the same. More particularly, the present general inventive concept relates to a nozzle of a printer head which can assure straightness of an ink and precisely jet an ink drop to a certain location on a printing paper sheet since a waterproof layer is formed on a path of the nozzle to a certain depth and the ink is evenly filled therein, and a method of manufacturing the nozzle.

2. Description of the Related Art

An inkjet printer is generally an apparatus which can print an image in a desired location of a printing paper sheet by jetting ink drops via a plurality of nozzles positioned in a printer head array. Various types of methods may be utilized to jet the ink drops on a printing paper sheet. However, a thermal transfer ink jetting method in which bubbles can be quickly formed in a small ink case by heating a resistor is widely utilized. In the thermal transfer ink jetting method, the formed bubbles cause a very small amount of ink to be quickly jetted from the nozzles. In addition, a method of jetting ink drops by using a piezoelectric actuator has been developed. As described above, the inkjet printer prints a desired character or image on the printing paper sheet using ink drops jetted from the plurality of nozzles of the inkjet printer head array.

FIG. 1 is a cross-sectional view illustrating a configuration of a conventional inkjet printer head. Referring to FIG. 1, a path plate 10 is formed with a plurality of pressure chambers 11, a plurality of restrictors 12 and a manifold 13 constituting a path. A nozzle plate 20 is formed with a plurality of nozzles 22 corresponding to the plurality of pressure chambers 11, respectively. A piezoelectric actuator 40 is provided on a top surface of the path plate 10. Actuation of the piezoelectric actuator 40 changes a volume of the path plate 10, and thereby causes a pressure change for jetting or inflowing of an ink. To cause the volume change of the path plate 10, a diaphragm 14 is attached on a top surface of the pressure chamber 11 of the path plate 10 to deflect when the piezoelectric actuator 40 is actuated.

The piezoelectric actuator 40 includes a lower electrode 41, a piezoelectric film 42 and an upper electrode 43. A silicon dioxide film 31 is provided between the path plate 10 and the lower electrode 41.

When the ink drop is jetted from a nozzle, a jetting direction of the ink drop may be changed because a surface of the nozzle is wetted by the ink. Also, when removing the ink and impurities from around the nozzle so as to continuously jet the ink drops, the nozzle may become damaged. To prevent the surface of the nozzle from becoming wetted, the surface of the nozzle plate 20 must be waterproofed. However, the inner surface of the nozzle must have a hydrophilic property.

Conventional inkjet printer heads will be further described in detail with reference to FIGS. 2 and 3. FIG. 2 is a cross-sectional view illustrating a conventional nozzle supplied with the ink, and FIG. 3 is a cross-sectional view illustrating a growing droplet of the ink from a conventional inkjet nozzle.

Referring to FIG. 2, when a waterproofed area is not symmetrical in a path of the nozzle 22, an ink 21 unevenly fills in the nozzle 22. This causes deterioration of straightness of the jetted ink 21. Referring to FIG. 3, the ink 21 jetted via the nozzle 22 formed on the nozzle plate 20 is smeared on the nozzle plate 20 around the nozzle 22. Also, a droplet of the ink 21 forms on an outside of the nozzle 22.

When the ink is smeared around the nozzle 22 or the droplet of ink forms on the outside of the nozzle 22, the behavior of the ink 21 on the nozzle 22 directly affects an ink jetting performance, such as straightness of the jetted ink 21 and an ink jetting speed. Namely, the ink 21 may not precisely reach a particular location on a printing paper sheet whereby a desired image may not be properly printed out or the ink 21 may become smeared on the nozzle plate 20.

Accordingly, while the inner surface of the nozzle 22 must have a hydrophilic property so as to induce the ink 21 toward the nozzle, the outer surface of the nozzle plate 20 of the nozzle 22 must have a waterproof property, i.e. a hydrophobic property, so as to prevent smearing of an ink or developing of a droplet. Also, the inner surface of the path of the nozzle 22 bordering the outside may be partially waterproofed.

A conventional method of applying a water-repellent coating on the outer surface of a nozzle plate has been developed. The Japanese Patent Laid-Open Publication No. hei 7-314693 is a representative example which discloses a method of forming a waterproof layer on an outer surface of a nozzle plate while not coating a waterproof layer on an inner surface of a nozzle, and then blowing a gas for helping straightness of an ink droplet. However, since an apparatus adopting the conventional method is very complicated while its process is also very difficult, the method is not practical.

Also, the Korean Patent Laid-Open Publication No. 10-2005-0087638 discussed a method of forming a hydrophobic coating film on the outer surface of a nozzle plate by dissolving the nozzle plate in a solution containing a sulfur compound. However, in this method, it is very difficult to symmetrically form a hydrophobic coating film and a hydrophilic material around a nozzle. When manufacturing a packaged product on a wafer level, it may be even more difficult to symmetrically form a hydrophobic coating film and hydrophilic material.

### SUMMARY OF THE INVENTION

The present general inventive concept provides a nozzle of an inkjet printer head in which a waterproof layer is formed on a path of a nozzle to a certain depth and an ink is evenly filled therein, and a method of manufacturing the same.

The present general inventive concept also provides a nozzle of an inkjet printer head which can effectively be produced on a wafer level to allow a high productivity, a low manufacturing cost, and excellent precision, and a method of manufacturing the same by a simple process.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of manufacturing nozzles of an inkjet printer head, including providing a nozzle plate formed with a plurality of nozzles each having a path to guide an ink, forming a seed metal layer on an outer surface of the nozzle plate and a portion of the path of the nozzle, attaching a tape on the outer surface of the nozzle plate to seal the nozzle, filling the path of the nozzle with a liquid photocurable resin, hardening the photocurable resin by emitting a light onto the nozzle plate, removing the tape, externally exposing a portion of the seed metal layer within the path of the nozzle and the outer surface of the nozzle plate, and removing the hardened photocurable resin.

In the providing of the nozzle plate, the nozzle plate may be performed using a plurality of nozzles by constructing the nozzle plate from a silicon wafer. Productivity may be improved by using a wafer level packaging technology. Also, the tape may be an ultraviolet detachable tape which can be easily detached after exposure to ultraviolet rays.

In the filling of the path of the nozzle with the liquid photocurable resin may include a spray coater spraying a liquid photocurable material or a spin coating method. The removing of the sacrificial material may include etching the photocurable resin by using a reactive ion etching (RIE) or an asher. Also, the waterproof layer may be a eutectoid nickel with fluorine resin and formed by electro or electroless plating.

The foregoing and/or other aspects and utilities of the present general inventive concept may also be achieved by providing an inkjet printer head nozzle unit including a nozzle plate formed with a plurality of nozzles each to provide a path to guide an ink, a seed metal layer formed on a portion of the path of each nozzle and an outer surface of the nozzle plate, and a waterproof layer formed on the seed metal layer so as to only partially cover the seed metal layer formed in the path of each nozzle. The path of the nozzle may be formed by removing the photocurable resin.

The foregoing and/or other aspects and utilities of the present general inventive concept may also be achieved by providing a method of manufacturing a nozzle of an inkjet printer head, the method including providing a nozzle plate formed with a plurality of nozzles having a path to guide an ink, filling a sacrificial material in the path of the nozzle of the nozzle plate, removing the sacrificial material filled in the path of the nozzle from an outer surface of the nozzle plate to a predetermined depth, forming a waterproof layer on the outer surface of the nozzle plate and a wall surface of the path of the nozzle, and removing the remaining sacrificial material from the nozzle plate.

A seed metal layer may be formed on the outer surface of the nozzle plate and the path of the nozzle before filling the sacrificial material in the path of the nozzle, and the waterproof layer may be formed on the seed metal layer exposed on the surface of the nozzle plate and the path of the nozzle, by electroplating. Also, the waterproof layer may be formed of a eutectoid nickel with fluorine resin and may be performed by electro or electroless plating.

The foregoing and/or other aspects and utilities of the present general inventive concept may also be achieved by providing an inkjet nozzle unit having a nozzle plate including a plurality of nozzles, the inkjet nozzle unit including a waterproof layer symmetrically formed on an outer surface of the nozzle plate and extending to an interior surface of each nozzle of the plurality of nozzles by a predetermined distance from the outer surface.

The foregoing and/or other aspects and utilities of the present general inventive concept may also be achieved by providing a method of forming an inkjet printer head nozzle unit, the method including applying a seed metal layer to an outer surface of a nozzle plate having a plurality of nozzles so that the seed metal layer extends into a portion of the nozzles having a constant diameter to a predetermined depth, and applying a symmetric water proof layer to the seed metal layer so that the water proof layer extends into the nozzles to a depth that is less than the predetermined depth.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view illustrating a conventional configuration of an inkjet printer head;

FIG. 2 is a cross-sectional view illustrating a conventional nozzle supplied with an ink;

FIG. 3 is a cross-sectional view illustrating a growing droplet from a conventional inkjet;

FIG. 4 is a cross-sectional view illustrating a nozzle of an inkjet printer head according to the present general inventive concept;

FIG. 5 is a cross-sectional view illustrating the nozzle plate formed with the nozzle of FIG. 4;

FIG. 6 is a cross-sectional view illustrating the seed metal layer formed on the nozzle plate and in a path of the nozzle of FIG. 5;

FIG. 7 is a cross-sectional view illustrating a tape attached on the nozzle plate of FIG. 6;

FIG. 8 is a cross-sectional view illustrating a liquid photocurable resin filled in the nozzle of FIG. 7;

FIG. 9 is a cross-sectional view illustrating the hardened photocurable resin by emitting ultraviolet rays to the nozzle plate of FIG. 8;

FIG. 10 is a cross-sectional view illustrating the nozzle plate of FIG. 9 after removing the tape;

FIG. 11 is a cross-sectional view illustrating a partial etching of the hardened photocurable resin of FIG. 9;

FIG. 12 is a cross-sectional view illustrating a formed waterproof layer on the nozzle of FIG. 11; and

FIG. 13 is a cross-sectional view illustrating an appearance of the nozzle of FIG. 12 after removing the photocurable resin.

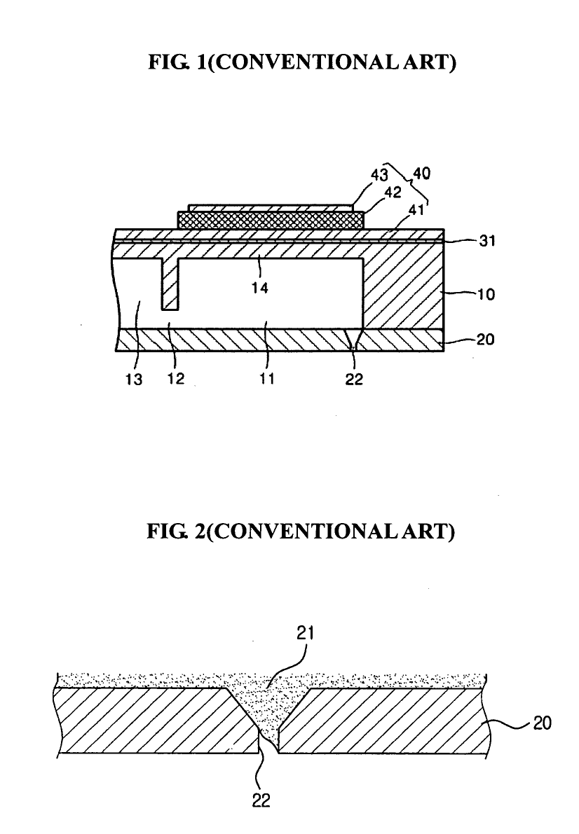

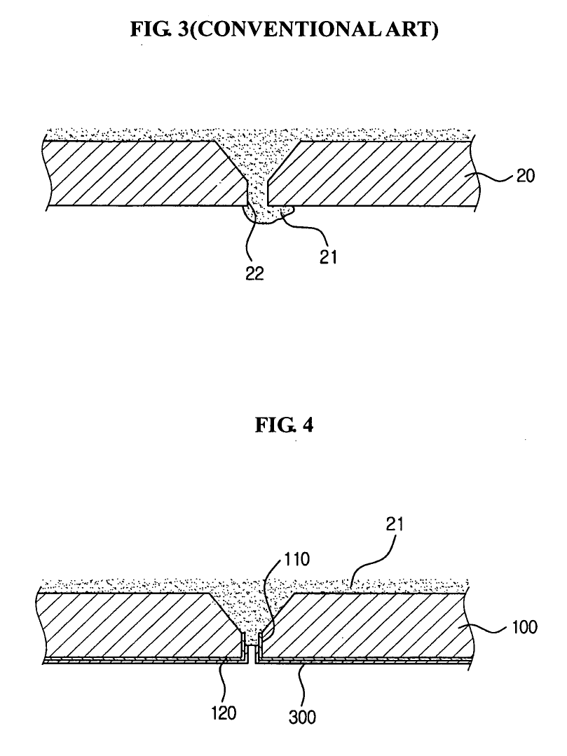

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 4 is a cross-sectional view illustrating a nozzle 110 of an inkjet printer head according to an embodiment of the present general inventive concept. Referring to FIG. 4, a plurality of nozzles 110 (only one illustrated) is formed on a nozzle plate 100. The nozzles 110 are in the shape of a cylinder having a cylindrical portion with a constant diameter near an outer surface of the nozzle plate 100, and each nozzle 110 has an increasing diameter that expands as it gets closer towards an inner surface of the nozzle plate 100. The cylindrical portion of the nozzle 110 starts to expand at a predetermined distance from the outer surface of the nozzle plate 100.

The cylindrical portion of the nozzle 110 having the constant diameter is covered with a seed metal layer 120. Also, a part of the cylindrical portion of the nozzle 110 having the seed metal layer 120 is coated with a waterproof layer 300. The waterproof layer 300 is coated on a portion of the inside of the nozzle 110 and the surface of the nozzle plate 100.

The waterproof layer 300 may be formed of a eutectoid nickel with fluorine resin, for example, Ni-PTFE (Ni-Teflon). Also, the waterproof layer 300 may be formed of a material having a waterproof property as well as excellent durability and abrasion resistance.

An ink 21 is jetted via the nozzle 110 and makes contact only with the inside of the nozzle 110 where the waterproof layer 300 is not formed. In this instance, the waterproof layer 300 formed in the nozzle 110 is substantially symmetrically formed. Accordingly, a straightness of the ink 21 that is jetted from the nozzle 110 is assured, which enables a precise image to be printed on a printing paper sheet. Since the waterproof layer 300 formed in the nozzle 110 is substantially symmetrically formed, the ink 21 will not be smeared on the nozzle plate 100.

Hereinafter, a manufacturing method according to an embodiment of the present general inventive concept will be described with reference to FIGS. 5-13.

FIG. 5 is a cross-sectional view illustrating a nozzle plate 100 formed with a nozzle 110 according to an embodiment of the present general inventive concept. Referring to FIG. 5, the nozzle plate 100 formed with a plurality of nozzles 110 (only one illustrated) is provided. Tens or hundreds of nozzles 110 are formed in a line or in a plurality of lines on the nozzle plate 100. The nozzle plate 100 may simultaneously produce each nozzle 110 by initially manufacturing the plurality of nozzles 110 using a silicon wafer, and dicing the plurality of nozzles 110. The nozzle plate 100 may utilize a glass substrate or a metal substrate. The nozzle plate 110 may also be manufactured by manufacturing the plurality of nozzles 110 on a silicon wafer by using a wafer level package technology and dicing the plurality of nozzles 110

As described above, the nozzle 110 is in the shape of a cylinder having a constant diameter towards an outer surface of the nozzle plate 100, and an increasing diameter region as the inner surface thereof extends towards an inner surface of the nozzle plate 100. The cylindrical portion of the nozzle 110 starts to expand at a predetermined distance inward from the outer surface of the nozzle plate 100.

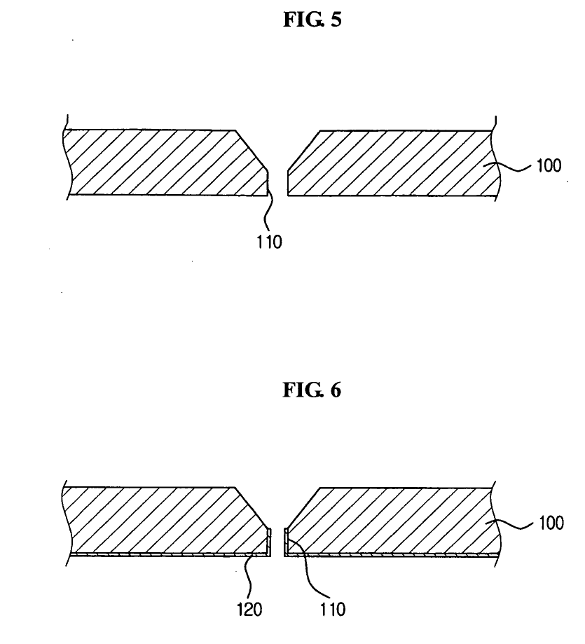

FIG. 6 is a cross-sectional view illustrating a seed metal layer 120 formed on the nozzle plate 100 and in a path of the nozzle 110 of FIG. 5. Referring to FIG. 6, the seed metal layer 120 is formed on the surface of the nozzle plate 100 and along the path of the cylindrical portion of the nozzle 110 having the constant diameter. In this instance, the seed metal layer 120 may be formed of any one of Au, Ag, Cu and In, or an alloy of at least two thereof.

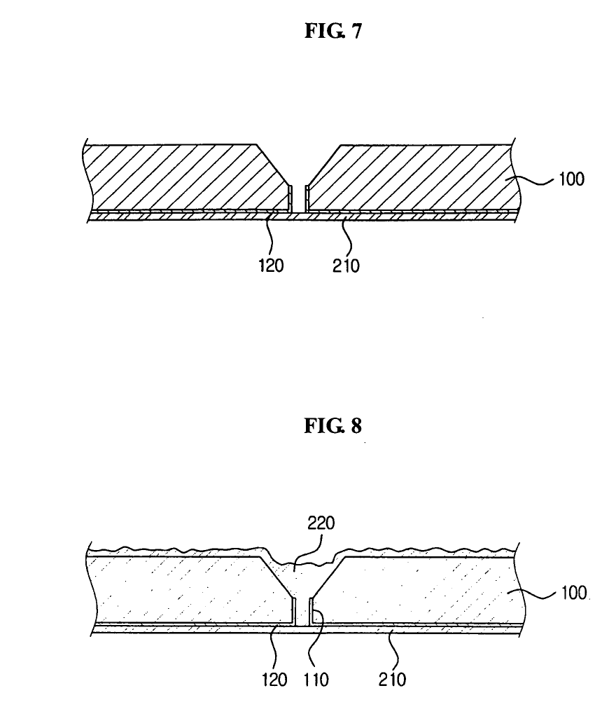

FIG. 7 is a cross-sectional view illustrating a tape 210 attached along the nozzle plate 100 of FIG. 6 over the seed metal layer 120. Referring to FIG. 7, the tape 210 is to the seed metal layer 120 so as to seal the nozzle 110. In one example, the tape 210 may be a UV detachable tape which can be easily detached when exposed to ultraviolet rays. Furthermore, the UV detachable tape may be an adhesive tape in the form of a resin film on which a copper clad having a thickness of approximately 9 to 18 μm is laminated. Accordingly, the UV detachable tape may be tightly adhered but is easily detached by ultraviolet rays.

FIG. 8 is a cross-sectional view illustrating a liquid photocurable resin 220 filled in the nozzle 110 of FIG. 7. Referring to FIG. 8, the liquid photocurable resin 220 fills in the path of the cylindrical portion of the nozzle 110. In this instance, the photocurable resin 220 reacts to the light including ultraviolet rays and is hardened. In the present embodiment, a photocurable resin has been described as an example, but any type of material which can fill in the nozzle 110 and then be etched may be utilized. The material as described above may be referred to as a sacrificial material.

The photocurable resin 220 may be applied by using a spray coater to spray the liquid photocurable material via a spray or a spin coating method. In the spin coating method, a material to be coated is rotated on a rotating plate and a high molecule material is dropped on the center of the rotating plate, the high molecule material is then thinly spread over the surface of the rotating plate due to a centrifugal force caused by the rotating plate.

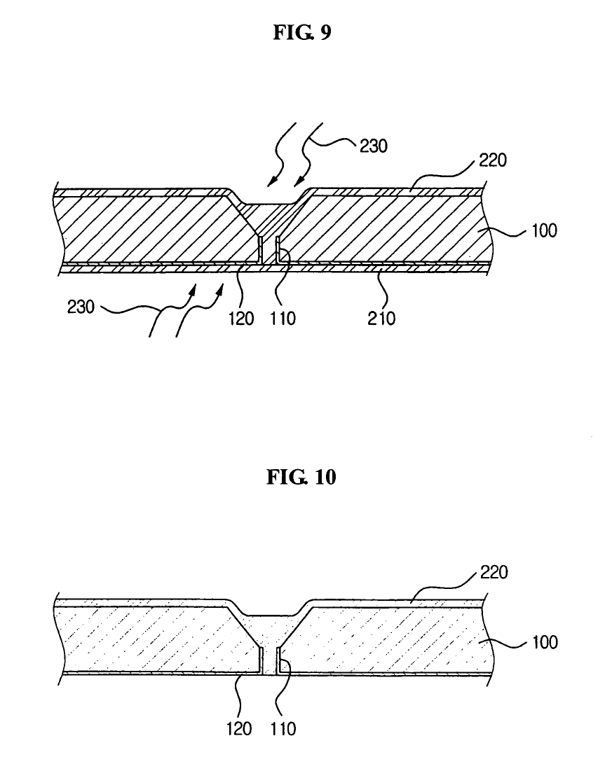

FIG. 9 is a cross-sectional view illustrating the hardening of the photocurable resin 220 by emitting ultraviolet rays 230 on to the nozzle plate 100 of FIG. 8. Referring to FIG. 9, the photocurable resin 220 is hardened by emitting ultraviolet rays 230 onto the nozzle plate 100. The photocurable resin 220 is hardened as polymerizable monomers absorb the ultraviolet rays 230 and chemically react so as to become dry. Also, when the UV detachable tape is utilized as the tape 210 and is exposed to the ultraviolet rays 230, the tape 210 may be in an easily detachable state after a hardening of the photocurable resin 220.

FIG. 10 is a cross-sectional view illustrating the nozzle plate 100 of FIG. 9 after removing the tape 210. Referring to FIG. 10, the tape 210 which is in the easily detachable state has been easily removed because the emitting of the ultraviolet rays 230 reduces an adhesive quality of the tape 210. The photocurable resin 220 fills in the path of the nozzle 110 and also is hardened.

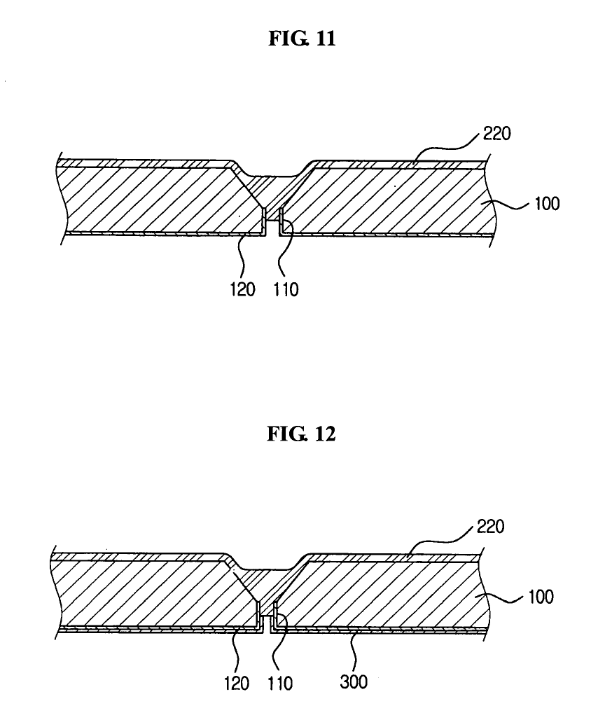

FIG. 11 is a cross-sectional view illustrating a partial etching of the hardened photocurable resin 220 on the nozzle plate 100 of FIG. 10. Referring to FIG. 11, only a portion of the seed metal layer 120 within the path of the nozzle 110 is externally exposed by partially etching the photocurable resin 220 filled in the path of the nozzle 110. Etching is vertically performed with respect to the nozzle plate 100. In this instance, the photocurable resin 220 may be etched according to a reactive ion etching (RIE) method in which straightness of an ink to be jetted is excellent, or may be etched by using an asher capable of preventing a damage caused by a plasma. Namely, by partially externally exposing the seed metal layer 120 using etching, the partially exposed surfaces of the seed metal layer 120 in a portion of the path of the nozzle 110 are symmetrical.

FIG. 12 is a cross-sectional view illustrating forming of the waterproof layer 300 on the nozzle plate 100 of FIG. 5. Referring to FIG. 12, the waterproof layer 300 is formed on the seed metal layer 120. In this instance, the waterproof layer 300 is formed only on the externally exposed surface of the seed metal layer 120. In other words, the waterproof layer 300 is formed only on the surface of the nozzle plate and a portion of the path of the nozzle 110.

As described above, the waterproof layer 300 may be made of a eutectoid nickel with fluorine resin, for example, Ni-PTFE (Ni-Teflon). Also, the waterproof layer 300 may be formed of a material having a waterproof property and also excellent durability and abrasion resistance. In this instance, the waterproof layer 300 may be formed by electro or electroless plating.

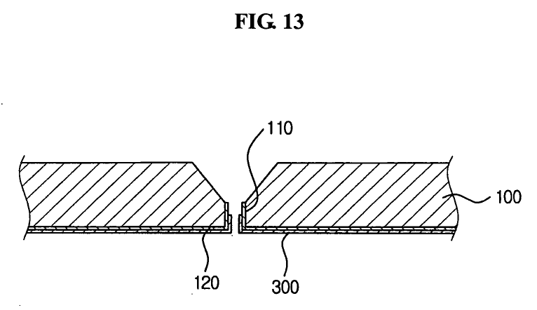

FIG. 13 is a cross-sectional view illustrating the nozzle 110 of FIG. 12 after removing the photocurable resin 220. Referring to FIG. 13, the hardened photocurable resin 220 is coated in a solvent, dissolved, and removed. A path to guide the ink 21 is formed in the nozzle 110 in which the hardened photocurable resin 220 is removed. An ink drop is jetted via the nozzle 110, but makes contact only with the inside of the nozzle 110 in which the waterproof layer 300 is not formed. That is, since the waterproof layer 300 is symmetrically formed on the nozzle plate 100 to a predetermined depth, the ink 21 does not smear on the outer surface of the nozzle plate 100. Since the ink is not smeared on the nozzle plate 100, straightness of the jetted ink 21 can be assured.

Also, a coating location of the waterproof layer 300 can be accurately determined by etching the hardened photocurable resin 220 in the path of the nozzle 110. Accordingly, it is possible to prevent the ink 21 from unevenly filling in the path of the nozzle 110. Since the ink 21 is prevented from unevenly filling in the path of the nozzle 110, an ink drop can be accurately jetted on a printing paper sheet.

As described above, according to the embodiments of the present general inventive concept, since a waterproof layer is evenly formed in a path of a nozzle at a certain depth, an ink can evenly fill in the path of the nozzle. Accordingly, it is possible to improve straightness of an ink, thereby enabling accurate printing.

Also, according to the embodiments of the present general inventive concept, a phenomenon that an ink droplet develops to an outside of the nozzle and prevents straightness of an ink can be effectively eliminated.

Also, according to the embodiments of the present general inventive concept, since a manufacturing process of a nozzle of an inkjet printer head is comparatively simple, productivity may be improved, a manufacturing cost may be low, and its precision may also be superb. Accordingly, it is possible to effectively produce each nozzle on a wafer level.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a nozzle of an inkjet printer head, the method comprising:
providing a nozzle plate formed with a plurality of nozzles having a path to guide an ink;
filling a sacrificial material in the path of the nozzle of the nozzle plate;
removing the sacrificial material filled in the path of the nozzle from an outer surface of the nozzle plate to a predetermined depth;
forming a waterproof layer on the outer surface of the nozzle plate and a wall surface of the path of the nozzle; and
removing the remaining sacrificial material from the nozzle plate.

2. The method of claim 1, further comprising:
forming a seed metal layer on the outer surface of the nozzle plate and the path of the nozzle before the filling of the sacrificial material in the path of the nozzle; and
wherein the waterproof layer is formed on the seed metal layer exposed on the outer surface of the nozzle plate and the path of the nozzle by electroplating.

3. The method of claim 1, wherein the sacrificial material is made of a liquid photocurable resin, a resin blocking layer is formed on the outer surface of the nozzle plate, and the liquid photorcurable resin coats the nozzle plate and fills in the path of the nozzle by using the resin blocking layer.

4. The method of claim 3, wherein the resin blocking layer is a tape applied with an adhesive material.

5. The method of claim 4, wherein the tape is an ultraviolet detachable tape that is easily detached when exposed to ultraviolet rays.

6. The method of claim 1, wherein the providing of the nozzle plate includes providing a plurality of nozzles by constructing the nozzle plate from a silicon wafer.

7. The method of claim 1, wherein the removing of the sacrificial material includes etching the sacrificial material by using a reactive ion etching (RIE).

8. The method of claim 1, wherein the removing of the sacrificial material includes etching the sacrificial material by using an asher.

9. A method of manufacturing nozzles of an inkjet printer head, the method comprising:
providing a nozzle plate formed with a plurality of nozzles each having a path to guide an ink;
forming a seed metal layer on an outer surface of the nozzle plate and a portion of the path of the nozzle;
attaching a tape on the outer surface of the nozzle plate to seal the nozzle;
filling the path of the nozzle with a liquid photocurable resin;
hardening the photocurable resin by emitting a light onto the nozzle plate;
removing the tape;
externally exposing a portion of the seed metal layer within the path of the nozzle by etching the photocurable resin;
forming a waterproof layer by coating the exposed seed metal layer formed in the path of the nozzle and the outer surface of the nozzle plate; and
removing the hardened photocurable resin.

10. The method of claim 9, wherein the filling of the path of the nozzle with the liquid photocurable resin is performed using a spin coating method.

11. The method of claim 9, wherein the filling of the path of the nozzle with liquid photocurable resin is performed using a spray coater spraying a liquid photocurable material.

12. The method of claim 9, wherein the waterproof layer is formed of a eutectoid nickel with fluorine resin.

13. The method of claim 9, wherein the forming of the waterproof layer is performed by an electro or electroless plating.

14. An inkjet printer head nozzle unit, comprising:
a nozzle plate formed with a plurality of nozzles each to provide a path to guide an ink;
a seed metal layer formed on a portion of the path of each nozzle and an outer surface of the nozzle plate; and
a waterproof layer formed on the seed metal layer so as to only partially cover the seed metal layer formed in the path of each nozzle.

15. The inkjet printer head nozzle unit of claim 14, wherein the nozzle plate comprises a silicon wafer.

16. The inkjet printer head nozzle unit of claim 14, wherein the seed metal layer is formed of any one selected from the group consisting of Au, Ag, Cu and In, and an alloy of at least two thereof.

17. The inkjet printer head nozzle unit of claim 14, wherein the waterproof layer is formed from a eutectoid nickel with fluorine resin.

18. An inkjet nozzle unit having a nozzle plate including a plurality of nozzles, the inkjet nozzle unit comprising:
a waterproof layer symmetrically formed on an outer surface of the nozzle plate and extending to an interior surface of each nozzle of the plurality of nozzles by a predetermined distance from the outer surface.

19. The inkjet nozzle unit of claim 18, further comprising:
a seed metal layer formed between the waterproof layer and the nozzle plate, the seed metal layer extending into each nozzle past the waterproof layer to a second predetermined distance from the outer surface.
